(19) United States
(12) Patent Application Publication
(10) Pub. No.: US 2013/0124154 A1
(43) Pub. Date: May 16, 2013

(54) APPARATUS AND METHOD FOR AUTOMATIC AND OPTIMAL ARRANGEMENT OF BUILDING ENERGY CONTROL SENSORS

(71) Applicant: Electronics and Telecommunications Research In, Daejeon (KR)

(72) Inventors: Jong Won KIM, Daejeon (KR); Youn Kwae JEONG, Daejeon (KR); Il Woo LEE, Daejeon (KR)

(73) Assignee: Electronics and Telecommunications Research Institute, Daejeon (KR)

(21) Appl. No.: 13/672,039

(22) Filed: Nov. 8, 2012

(30) Foreign Application Priority Data
Nov. 10, 2011 (KR) 10-2011-0117086

(51) Int. Cl. G06F 17/50

(52) U.S. Cl. CPC G06F 17/50
USPC 703/1

(57) ABSTRACT

An apparatus optimally and automatically arranges a plurality of energy control sensors in a building. The apparatus includes an input module to receive building information, floor information of the building, structural information of rooms and corridors for each floor of the building, and receive information on one or more the energy control sensors to be installed in the building. The apparatus includes a sensor simulation module configured to calculate arrangement coordinates and installation expense for each of the selected energy control sensors to be installed in the building, and an output module configured to output the arrangement coordinates and the installation expense, which have been calculated sensor simulator for each selected energy control sensor.

### RELATED APPLICATION(S)

This application claims the benefit of Korean Patent Application No. 10-2011-0117086, filed on Nov. 10, 2011, which is hereby incorporated by reference as if fully set forth herein.

### FIELD OF THE INVENTION

The present invention relates to a building energy management system, and more particularly, to an apparatus and method for optimally and automatically arranging a plurality of energy control sensors to manage and control building energy and environment.

### BACKGROUND OF THE INVENTION

A wireless sensor network, which collects and analyzes detailed information through a plurality of control points installed in various field equipments and manages various sensors for maintaining a pleasant office environment and reducing energy consumption in an automatic control scheme, is generally established in buildings such as office buildings, for optimally managing building facilities and saving energy.

However, a conventional wireless sensor network system is capable of including only a plurality of sensor nodes, a gateway, and a server that are restrictively applied to the wireless sensor network, and cannot be applied to wired/wireless networks other than the wireless sensor network.

### SUMMARY OF THE INVENTION

In view of the above, the present invention provides an apparatus and method for automatically and optimally arranging a plurality of energy control sensors in order for managing and controlling a building energy and environment.

In accordance with a first aspect of the present invention, there is provided an apparatus for optimally and automatically arranging a plurality of energy control sensors in a building, the apparatus including: an input module configured to receive building information, floor information of the building, structural information of rooms and corridors for each floor of the building, and information on one or more energy control sensors to be installed in the building; a sensor simulation module configured to calculate arrangement coordinates and installation expense for each of the energy control sensors to be installed in the building; and an output module configured to output the arrangement coordinates and the installation expense, which have been calculated sensor simulator for each energy control sensor to be installed.

In the apparatus, the input module includes: a building information unit configured to store the building information and information on sizes and shapes of the floors, rooms, and corridors of the building; a floor information unit configured to store information on the floors of the building; a structure information unit configured to store information on the rooms and corridors in each of the floors of the building, on the basis of the information on the floors; and a distribution unit configured to provide sensor simulation starting signals for the energy control sensors to be installed to the sensor simulation module, on the basis of the information, stored in the floor information unit and the structure information unit, on the floor and room of each corridor of the building, so that the sensor simulation module calculates the arrangement coordinates and installation expense for each of the selected energy control sensors.

In the apparatus, the sensor simulator module includes: an optimal area calculation unit configured to calculate an optimal area of each energy control sensor to be installed in the building; an optimal number calculation unit configured to calculate an optimal number of energy control sensors to be installed in the building on the basis of the calculated optimal area; an optimal arrangement unit configured to determine an installation position of each energy control sensor to be installed in the building on the basis of the calculated optimal number and the information on the room and corridor of the building; an optimal unit sum calculation unit configured to calculate an optimal unit sum of each energy control sensor; and an optimal sum total calculation unit configured to calculate an optimal sum total of energy control sensors to be installed in the building on the basis of the calculated unit sum and the calculated optimal number.

In the apparatus, the optimal area calculation unit calculates an optimal area that each energy control sensor covers, in consideration of a measurement accuracy and installation expense of each sensor.

In the apparatus, each of the energy control sensors include a temperature sensor, a humidity sensor, a temperature-humidity sensor, an illumination sensor, an occupancy sensor, a CO₂ sensor, or a fine dust sensor.

In accordance with a second aspect of the present invention, there is provided a method of optimally and automatically arranging a plurality of energy control sensors in a building, the method including: providing building information, floor information of the building, structural information of rooms and a corridor for each floor of the building; providing information on one or more energy control sensors to be installed in the building; calculating arrangement coordinates and installation expense for each of the energy control sensors to be installed in the building; and outputting information on the calculated arrangement coordinates and the calculated installation expense for each of the energy control sensors to be installed in the building.

Preferably, the method includes: storing information on floors of the building; and storing the structural information on sizes and shapes of the rooms and corridors for each floor of the building.

Preferably, the providing information on one or more energy control sensors to be installed in the building comprises: providing information on the energy control sensors to be installed in the rooms and corridors of each floor on the basis of the information on the floors, rooms, and corridors of the building; and providing a sensor simulation starting signal for the energy control sensors to be selected to calculate the arrangement coordinates and installation expense for each of the identified energy control sensors.

In the method, the calculating arrangement coordinates and installation expense includes: calculating an optimal area of each energy control sensor to be installed in the building; calculating an optimal number of energy control sensors to be installed in the building on the basis of the calculated optimal area; determining an optimal installation position of each energy control sensor in the building on the basis of the calculated number and the information on the rooms and corridors of the building; calculating an optimal unit sum of energy control sensors to be installed in the building; and calculating an optimal sum total of energy control sensors to be installed in the building on the basis of the calculated unit sum and the calculated number.

In the method, the calculating an optimal area includes calculating the optimal area that each energy control sensor covers, in consideration of a measurement accuracy and installation expense of each energy control sensor.

In the method, each of the energy control sensors include a temperature sensor, a humidity sensor, a temperature-humidity sensor, an illumination sensor, an occupancy sensor, a CO₂ sensor, or a fine dust sensor.

### BRIEF DESCRIPTION OF THE DRAWINGS

The above and other objects and features of the present invention will become apparent from the following description of embodiments given in conjunction with the accompanying drawings, in which:

FIGS. 1A and 1B illustrate a block diagram of an apparatus for automatically and optimally arranging energy control sensors in a building in accordance with an embodiment of the present invention; FIG. 2 illustrates a detailed block diagram of an input module shown in FIG. 1A in accordance with an embodiment of the present invention;

FIG. 3 illustrates a detailed block diagram of a temperature sensor simulator shown in FIG. 1A in accordance with an embodiment of the present invention;

FIG. 4 illustrates a detailed block diagram of a humidity sensor simulator shown in FIG. 1A in accordance with an embodiment of the present invention;

FIG. 5 illustrates a detailed block diagram of a temperature-humidity sensor simulator shown in FIG. 1A in accordance with an embodiment of the present invention;

FIG. 6 illustrates a detailed block diagram of an illumination sensor simulator shown in FIG. 1A in accordance with an embodiment of the present invention;

FIG. 7 illustrates a detailed block diagram of an occupancy sensor simulator shown in FIG. 1A in accordance with an embodiment of the present invention;

FIG. 8 illustrates a detailed block diagram of a CO₂ sensor simulator shown in FIG. 1A in accordance with an embodiment of the present invention; and

FIG. 9 illustrates a detailed block diagram of a fine dust sensor simulator shown in FIG. 1A in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

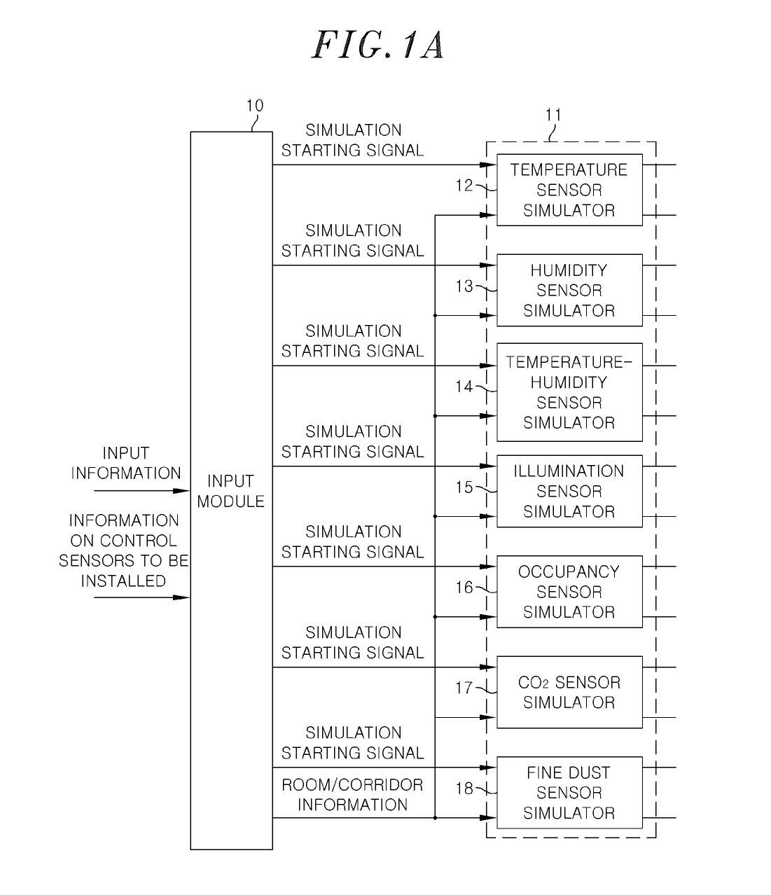

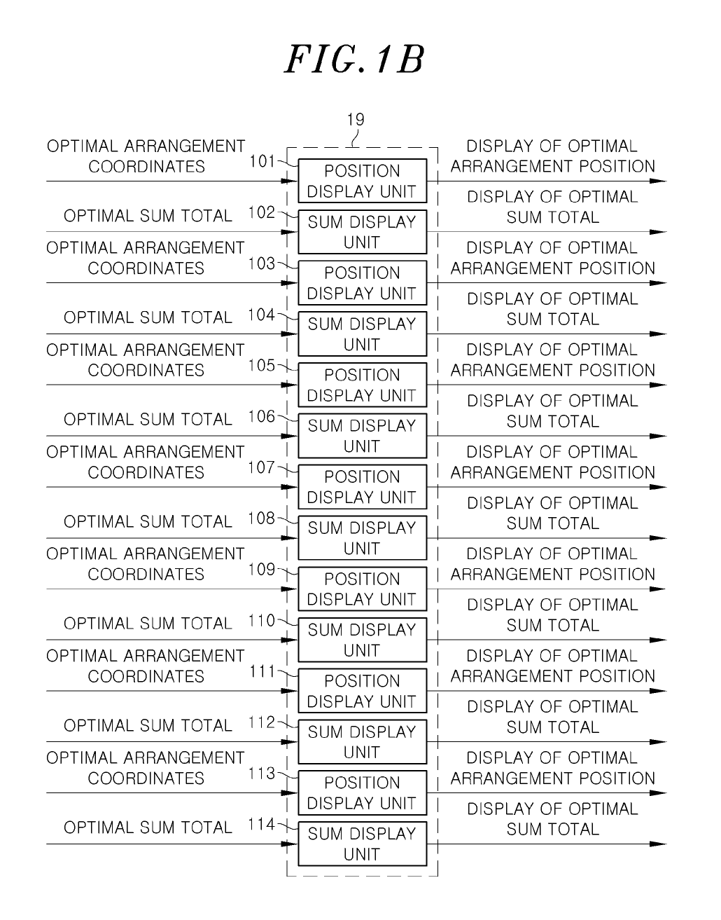

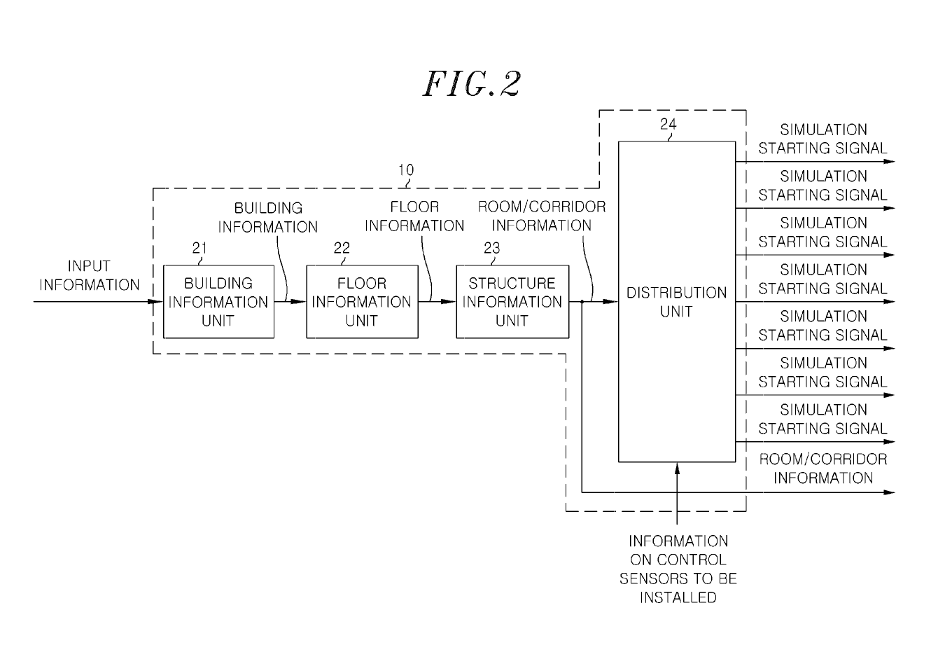

FIGS. 1A and 1B illustrate a block diagram of an apparatus for automatically and optimally arranging a plurality of energy control sensors employed to manage and control a building energy and environment in accordance with an embodiment of the present invention.

The apparatus includes an input module 10, a sensor simulation module 11, and an output module 19. The energy control sensors to be installed in the building may include a temperature sensor, a humidity sensor, a temperature-humidity sensor, an illumination sensor, an occupancy sensor, a CO₂ sensor, and a fine dust sensor. The input module 10 receives information on a building, floors, room sizes, corridor sizes, room shapes, and corridor shapes of the building from a user or a computer, and stores the building information, the floor information, the room information, and the corridor information. Further, the input module 10 receives information on one or more energy control sensors to be installed in the building and provides sensor simulation starting signals for one or more energy control sensors to be installed to the sensor simulation module 11 in order for simulating optimal arrangement coordinates and installation expenses of the energy control sensors to be installed. The simulator module 11 includes a temperature sensor simulator 12, a humidity sensor simulator 13, a temperature-humidity sensor simulator 14, an illumination sensor simulator 15, an occupancy sensor simulator 16, a CO₂ sensor simulator 17, and a fine dust sensor simulator 18 for the energy control sensors to be installed.

More specifically, the input module 10 provides a temperature sensor simulation starting signal for a temperature sensor to be installed to the temperature sensor simulator 12, along with the room information of the building, and the corridor information of the building.

Further, the input module 10 provides a humidity sensor simulation starting signal for a humidity sensor to be installed to the humidity sensor simulator 13 along with the room information and corridor information of the building; provides a temperature-humidity sensor simulation starting signal for a temperature-humidity sensor to be installed to the temperature-humidity sensor simulator 14 along with the room information and corridor information of the building; and provides an illumination sensor simulation starting signal for an illumination sensor to be installed to the illumination sensor simulator 15 along with the room information and corridor information of the building.

Further, the input module 10 provides an occupancy sensor simulation starting signal for an occupancy sensor to be installed to the occupancy sensor simulator 16 along with the room information and corridor information of the building; provides a CO₂ sensor simulation starting signal for a CO₂ sensor to be installed to the CO₂ sensor simulator 17 along with the room information and corridor information of the building; and provides a fine dust sensor simulation starting signal for a fine dust sensor to be installed to the fine dust sensor simulator 18 along with the room information and corridor information of the building.

The temperature sensor simulator 12, in response to the temperature sensor simulation starting signal and the room information and corridor information of the building from the input module 10, calculates an optimal number of temperature sensors on the basis of the optimal area per one temperature sensor, and calculates an optimal arrangement coordinates of temperature sensors in a two-dimensional (2D) or three-dimensional (3D) space. Also, the temperature sensor simulator 12 calculates an optimal sum total of temperature sensors on the basis of a unit sum of the temperature sensor and the optimal number of temperature sensors. The optimal arrangement coordinates of the temperature sensors and the optimal sum total of the temperature sensors are provided to the output module 19.

The humidity sensor simulator 13, in response to the humidity sensor simulation starting signal and the room information and corridor information of the building from the input module 10, calculates an optimal number of humidity sensors on the basis of an optimal area per one humidity sensor, and calculates an optimal arrangement coordinates for humidity sensors in the 2D or 3D space. Also, the humidity sensor simulator 13 calculates an optimal sum total of humidity sensors on the basis of a unit sum of humidity sensor and an optimal number of humidity sensors. The optimal arrangement coordinates of the humidity sensors and the optimal sum total of the humidity sensors are then provided to the output module 19.

The temperature-humidity sensor simulator 14, in response to the temperature-humidity sensor simulation starting signal and the room information and corridor information of the building from the input module 10, calculates an optimal number of temperature-humidity sensors on the basis of an optimal area per one temperature-humidity sensor, and calculates an optimal arrangement coordinates of temperature-humidity sensors in the 2D or 3D space. Also, the temperature-humidity sensor simulator 14 calculates an optimal sum total of the temperature-humidity sensors on the basis of a unit sum of the temperature-humidity sensor and the optimal number of temperature-humidity sensors. The optimal arrangement coordinates of the temperature-humidity sensors and the optimal sum total of the temperature-humidity sensors are provided to the output module 19.

The illumination sensor simulator 15, in response to the illumination sensor simulation starting signal and the room information and corridor information of the building from the input module 10, calculates an optimal number of illumination sensors on the basis of an optimal area per one illumination sensor, and calculates an optimal arrangement coordinates of the illumination sensors in the 2D or 3D space. Also, the illumination sensor simulator 15 calculates an optimal sum total of the illumination sensors on the basis of a unit sum of the illumination sensor and an optimal number of illumination sensors. The optimal arrangement coordinates of the illumination sensors and the optimal sum total of the illumination sensors are then provided to the output module 19.

The occupancy sensor simulator 16, in response to the occupancy sensor simulation starting signal and the room information and corridor information of the building from the input module 10, calculates an optimal number of occupancy sensors on the basis of an optimal area per one occupancy sensor, and calculates an optimal arrangement coordinates of occupancy sensors in the 2D or 3D space. Also, the occupancy sensor simulator 16 calculates an optimal sum total of occupancy sensors on the basis of a unit sum of occupancy sensor and an optimal number of occupancy sensors. The optimal arrangement coordinates of the occupancy sensors and the optimal sum total of the occupancy sensors are then provided to the output module 19.

The CO₂ sensor simulator 17, in response to the CO₂ sensor simulation starting signal and the room information and corridor information of the building from the input module 10, calculates an optimal number of CO₂ sensors on the basis of an optimal area per one CO₂ sensor, and calculates an optimal arrangement coordinates of CO₂ sensors in the 2D or 3D space. Also, the CO₂ sensor simulator 17 calculates an optimal sum total of the CO₂ sensors on the basis of a unit sum of the CO₂ sensor and the optimal number of CO₂ sensors. The optimal arrangement coordinates of the CO₂ sensors and the optimal sum total of the CO₂ sensors are then provided to the output module 19.

The fine dust sensor simulator 18, in response to the fine dust sensor simulation starting signal and the room information and corridor information of the building from the input module 10, calculates an optimal number of fine dust sensors on the basis of an optimal area per one fine dust sensor, and calculates an optimal arrangement coordinates of fine dust sensors in the 2D or 3D space. Also, the fine dust sensor simulator 18 calculates an optimal sum total of the fine dust sensors on the basis of a unit sum of fine dust sensor and an optimal number of fine dust sensors. The optimal arrangement coordinates of the fine dust sensors and the optimal sum total of the fine dust sensors are then provided to the output module 19.

The output module 19 receives and displays the information on the optimal arrangement coordinates of the respective energy control sensors and optimal sum totals of the respective energy control sensors that have been calculated by their corresponding sensor simulators.

The output module 19 includes a position display unit 101 and a sum display unit 102 for a thermal sensor; a position display unit 103 and a sum display unit 104 for a temperature sensor; a position display unit 105 and a sum display unit 106 for a temperature-humidity sensor; a position display unit 107 and a sum display unit 108 for a luminance sensor; a position display unit 109 and a sum display unit 110 for occupancy sensor; a position display unit 111 and a sum display unit 112 for CO₂ sensor; and a position display unit 113 and a sum display unit 114 for a fine dust sensor.

More specifically, the output module 19 receives the optimal arrangement coordinates of the temperature sensors and the optimal sum total of the temperature sensors from the temperature sensor simulator 12; receives the optimal arrangement coordinates of the humidity sensors and the optimal sum total of humidity sensors from the humidity sensor simulator 13; and receives the optimal arrangement coordinates of temperature-humidity sensors and the optimal sum total of the temperature-humidity sensors from the temperature-humidity sensor simulator 14.

Further, the output module 19 receives the optimal arrangement coordinates of the illumination sensors and the optimal sum total of the illumination sensors from the illumination sensor simulator 15; receives the optimal arrangement coordinates of the occupancy sensors and the optimal sum total of the occupancy sensors from the occupancy sensor simulator 16; receives the optimal arrangement coordinates of CO₂ sensors and the optimal sum total of the CO₂ sensors from the CO₂ sensor simulator 17; and receives the optimal arrangement coordinates of the fine dust sensors and the optimal sum total of the fine dust sensors from the fine dust sensor simulator 18.

Subsequently, the output module 19 displays the optimal arrangement coordinates of the respective energy control sensors for each room and corridor of the building in the 2D or 3D space.

More specifically, the output module 19 displays the optimal arrangement coordinates of the temperature sensors for each room and corridor of the building in the 2D or 3D space, displays the optimal sum total of the temperature sensors, displays the optimal arrangement coordinates of the humidity sensors for each room and corridor of the building in the 2D or 3D space, and displays the optimal sum total of the humidity sensors.

Further, the output module 19 displays the optimal arrangement coordinates of the temperature-humidity sensors for each room and corridor of the building in the 2D or 3D space, displays the optimal sum total of the temperature-humidity sensors, displays the optimal arrangement coordinates of the illumination sensors for each room and corridor of the building in the 2D or 3D space, displays the optimal sum total of the illumination sensors, displays the optimal arrangement coordinates of the occupancy sensors for each room and corridor of the building in the 2D or 3D space, and displays the optimal sum total of the occupancy sensors.

Further, the output module 19 displays the optimal arrangement coordinates of the CO₂ sensors for each room and corridor of the building in the 2D or 3D space, displays the optimal sum total of the CO₂ sensors, displays the optimal arrangement coordinates of the fine dust sensors for each room and corridor of the building in the 2D or 3D space, and displays the optimal sum total of the fine dust sensors.

FIG. 2 illustrates the detailed block diagram of the input module 10 shown in FIG. 1A in accordance with an embodiment of the present invention. The input module 10 includes a building information unit 21, a floor information unit 22, a structure information unit 23, and a distribution unit 24.

The building information unit 21 receives information on the building, floors, room sizes, corridor sizes, room shapes, and corridor shapes of the building, stores the building information, and provides the building information to the floor information unit 22. The floor information unit 22 receives the building information from the building information unit 21, stores the floor information on the building, and provides the floor information to a structure information unit 23.

The structure information unit 23 receives the floor information on the building from the floor information unit 22, stores the room and corridor information on the building and each floor thereof, and provides the room and corridor information on the building and each floor to the distribution unit 24. In addition, the room and corridor information on each floor of the building is also provided to the temperature sensor simulator 12, the humidity sensor simulator 13, the temperature-humidity sensor simulator 14, the illumination sensor simulator 15, the occupancy sensor simulator 16, the CO₂ sensor simulator 17, and the fine dust sensor simulator 18 that will be described below.

The distribution unit 24 receives the room and corridor information from the structure information unit 23, receives the information on one or more energy control sensors to be installed in each room and corridor, and provides the sensor simulation starting signal 12 for the energy control sensors to be installed to the sensor simulator 12.

That is, the distribution unit 24 provides the temperature sensor simulation starting signal for the temperature sensor to be selected to the temperature sensor simulator 13; the distribution unit 24 provides the humidity sensor simulation starting signal for the humidity sensor to be selected to the humidity sensor simulator 13; provides the temperature-humidity sensor simulation starting signal for the temperature-humidity sensor to be selected to the temperature-humidity sensor simulator 14; and provides the illumination sensor simulation starting signal for the illumination sensor to be selected to the illumination sensor simulator 15.

Further, the distribution unit 24 provides the occupancy sensor simulation starting signal for the occupancy sensor to be selected to the occupancy sensor simulator 16; provides the CO₂ sensor simulation starting signal for the CO₂ sensor to be selected to the CO₂ sensor simulator 17; and provides the fine dust sensor simulation starting signal for the fine dust sensor to be selected to the fine dust sensor simulator 18.

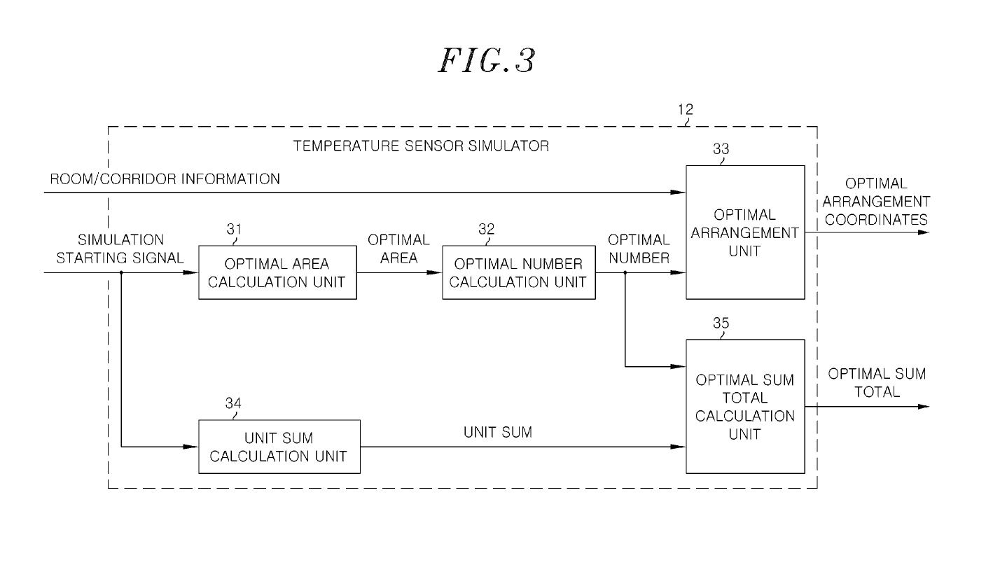

FIG. 3 illustrates the detailed block diagram of the temperature sensor simulator 12 shown in FIG. 1A in accordance with an embodiment of the present invention. The temperature sensor simulator 12 includes an optimal area calculation unit 31, an optimal number calculation unit 32, an optimal arrangement unit 33, a unit sum calculation unit 34, and an optimal sum total calculation unit 35. The temperature-sensor optimal area calculation unit 31 receives the temperature sensor simulation starting signal from the distribution unit 24, sets an optimal area of a temperature sensor as A1 (for example, A1 is 100 m², and is changeable) in terms of the accuracy of measurement and installation expense. The temperature-sensor optimal area A1 is then provided to the temperature-sensor optimal number calculation unit 32.

The temperature-sensor optimal number calculation unit 32 receives the temperature-sensor optimal area A1 from the optimal area calculation unit 31, and calculates the optimal number QO(T) of temperature sensors as expressed in Equation 1.

QO(T)=int((ST+A1)/A1), Eq. 1

where ST is the area of a room/a corridor

The temperature-sensor optimal number calculation unit 32 provides the optimal number QO(T) of temperature sensors to the optimal arrangement unit 33 and the optimal sum total calculation unit 35. The optimal arrangement unit 33 receives room/corridor information from the structure information unit 23 and the optimal number QO(T) of temperature sensors from the optimal number calculation unit 32 to calculate an optimal position of each temperature sensor.

An optimal horizontal position of a temperature sensor may be set a position PO(T) along the long central line of a room/corridor, wherein PO(T)=position(i/(QO(t)+1)) of an entire length, where i is an integer from one to QO(T). An optimal vertical position of a temperature sensor may be set at the central position between a ceiling and a bottom. However, when it is unable to dispose the temperature sensor at the central position, the temperature sensor may be disposed at the ceiling. Under such a condition, 2D/3D arrangement coordinates of the temperature sensors are calculated, and the calculated 2D/3D optimal arrangement coordinates are then provided to the temperature sensor position display unit 101 as shown in FIG. 1B.

The unit sum calculation unit 34 receives the temperature sensor simulation starting signal from the distribution unit 24 to set a unit sum of a temperature sensor. In this case, the unit sum calculation unit 34 sets the unit sum as A2 (for example, A2 is 150,000 [symbol] , and is changeable). The unit sum A2 is then provided to the optimal sum total calculation unit 35.

The optimal sum total calculation unit 35 receives the optimal number QO(T) of temperature sensors from the optimal number calculation unit 32 and the unit sum A2 from the unit sum calculation unit 34 to calculate the optimal sum total COT(T) of temperature sensors as expressed in Equation 2.

COT(T)=A2×QO(T) Eq. 2

Subsequently, the optimal sum total calculation unit 35 provides the optimal sum total COT(T) of the temperature sensors to the sum display unit 102 as shown in FIG. 1B.

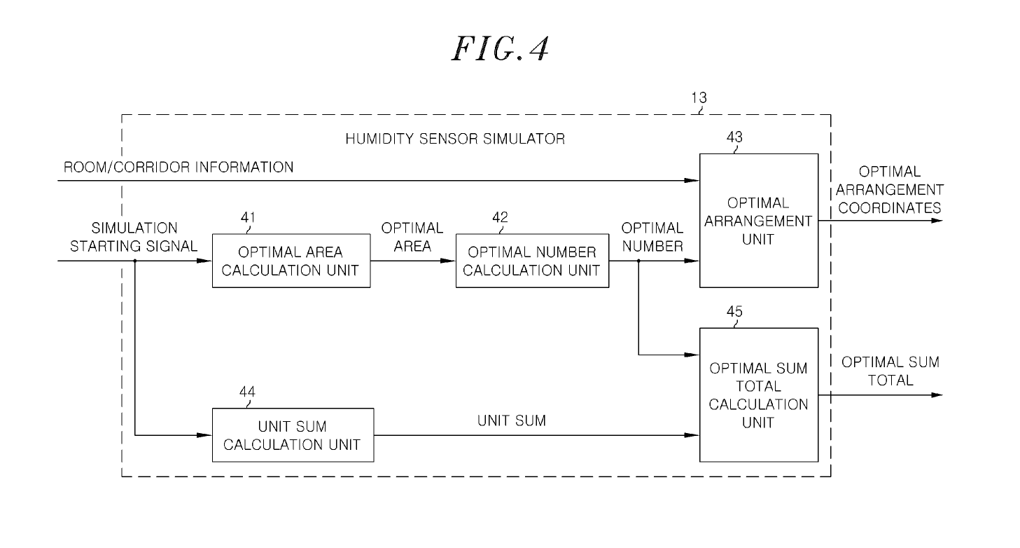

FIG. 4 illustrates a detailed block diagram of the humidity sensor simulator 13 shown in FIG. 1A in accordance with an embodiment of the present invention. The humidity sensor simulator 13 includes an optimal area calculation unit 41, an optimal number calculation unit 42, an optimal arrangement unit 43, a unit sum calculation unit 44, and an optimal sum total calculation unit 45.

The humidity-sensor optimal area calculation unit 41 receives the humidity sensor simulation starting signal from the distribution unit 24 and sets the optimal area of a humidity sensor as B1 (for example, B1 is 100 m², and is changeable) in terms of the accuracy of measurement and installation expense. The humidity-sensor optimal area B1 B1 is then provided to the optimal number calculation unit 42.

The optimal number calculation unit 42 receives the optimal area from the optimal area calculation unit 41, and calculates the optimal number QO(H) of humidity sensors as expressed in Equation 3.

QO(H)=int((ST+B1)/B1), Eq. 3

where ST is the area of a room/a corridor

The optimal number calculation unit 42 provides the optimal number QO(H) of humidity sensors to the optimal arrangement unit 43 and the optimal sum total calculation unit 45.

The optimal arrangement unit 43 receives room/corridor information from the structure information unit 23 and the optimal number of humidity sensors from the optimal number calculation unit 42 to calculate an optimal position of a humidity sensor.

An optimal horizontal position of the humidity sensor may be set a position PO(H) along the long central line of a room/corridor, wherein PO(H)=point(i/(QO(H)+1))of an entire length, where i is an integer from one to QO(H). An optimal vertical position may be set at the central position between a ceiling and a bottom. However, when it is unable to dispose the humidity sensor at the central position, the humidity sensor may be disposed at the ceiling. Under such a condition, 2D/3D arrangement coordinates of the humidity sensors are calculated, and the calculated 2D/3D optimal arrangement coordinates are then provided to the position display unit 103 as shown in FIG. 1B.

The unit sum calculation unit 44 receives the humidity sensor simulation starting signal from the distribution unit 24 to set a unit sum of a humidity sensor. In this case, the unit sum calculation unit 44 sets the unit sum as B2 (for example, B2 is 150,000 [symbol] , and is changeable). The unit sum B2 is then provided to the optimal sum total calculation unit 45.

The optimal sum total calculation unit 45 receives the optimal number QO(H) of humidity sensors from the optimal number calculation unit 42 and the unit sum B2 from the unit sum calculation unit 44 to calculate an optimal sum total COT(H) of humidity sensors as expressed in Equation 4.

COT(H)=B2×QO(H) Eq. 4

Subsequently, the optimal sum total calculation unit 45 provides the optimal sum total COT(H) of the humidity sensors to the sum display unit 104 as shown in FIG. 1B.

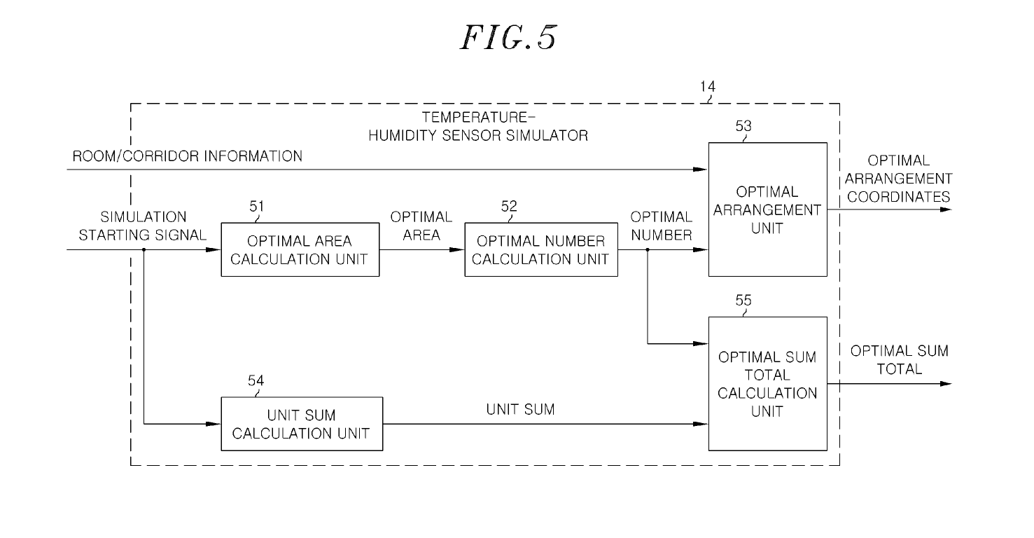

FIG. 5 illustrates the detailed block diagram of the temperature-humidity sensor simulator 14 shown in FIG. 1A in accordance with an embodiment of the present invention. The temperature-humidity sensor simulator 14 includes an optimal area calculation unit 51, an optimal number calculation unit 52, an optimal arrangement unit 53, a unit sum calculation unit 54, and an optimal sum total calculation unit 55.

The optimal area calculation unit 51 receives the temperature-humidity sensor simulation starting signal from the distribution unit 24, sets an optimal area of a temperature-humidity sensor as C1 (for example, C1 is 100 m², and is changeable) in terms of the accuracy of measurement and installation expense, and provides the temperature-humidity sensor optimal area C1 to the temperature-humidity sensor optimal number calculation unit 52.

The optimal number calculation unit 52 receives the temperature-humidity sensor optimal area C1 from the optimal area calculation unit 51, and calculates an optimal number QO(TH) of temperature-humidity sensors as expressed in Equation 5.

QO(TH)=int((ST+C1)/C1), 5

where ST is the area of a room/corridor

The optimal number calculation unit 52 provides the optimal number QO(TH) of temperature-humidity sensors to the optimal arrangement unit 53 and the optimal sum total calculation unit 55.

The optimal arrangement unit 53 receives room/corridor information from the structure information unit 23 and the optimal number QO(TH) of temperature-humidity sensors from the optimal number calculation unit 52 to calculate an optimal position of a temperature-humidity sensor.

An optimal horizontal position of the temperature-humidity sensor may be a position PO(TH) along the long central line of a room/corridor, wherein PO(TH)=point(i/(QO(TH)+1)) of an entire length, where i is an integer from one to QO(H). An optimal vertical position of the temperature-humidity sensor may be set at the central position between a ceiling and a bottom. However, when it is unable to dispose the sensor at the central position, the temperature-humidity sensor may be disposed at the ceiling. Under such a condition, 2D/3D arrangement coordinates of the temperature-humidity sensors are calculated, and the calculated 2D/3D optimal arrangement coordinates are provided to the position display unit 105 as shown in FIG. 1B.

The unit sum calculation unit 54 receives the humidity sensor simulation starting signal from the distribution unit 24 to set a unit sum of a humidity sensor. In this case, the unit sum calculation unit 54 sets the temperature-humidity sensor unit sum as C2 (for example, C2 is 150,000 [symbol] , and is changeable). The temperature-humidity sensor unit sum C2 is then provided to the optimal sum total calculation unit 55.

The optimal sum total calculation unit 55 receives the optimal number QO(TH) of temperature-humidity sensors from the optimal number calculation unit 52 and the temperature-humidity-sensor unit sum C2 from the unit sum calculation unit 54 to calculate an optimal sum total COT(TH) of the temperature-humidity sensors as expressed in Equation 6.

COT(TH)=C2×QO(TH) Eq. 6

Subsequently, the optimal sum total calculation unit 55 provides the optimal sum total COT(TH) of temperature-humidity sensors to the sum display unit 106 as shown in FIG. 1B.

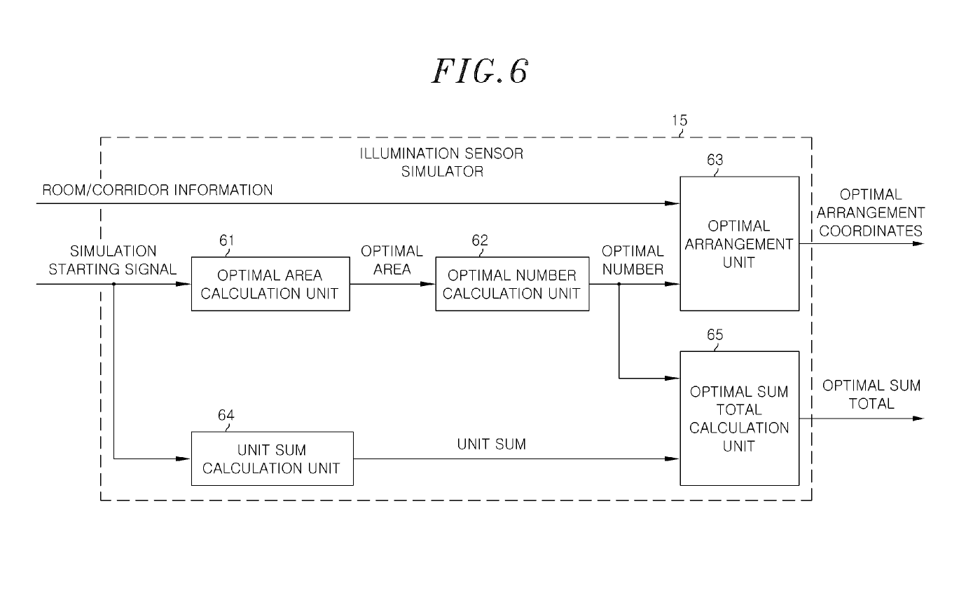

FIG. 6 illustrates the detailed block diagram of the illumination sensor simulator 15 shown in FIG. 1A in accordance with an embodiment of the present invention. The illumination sensor simulator 15 includes an optimal area calculation unit 61, an optimal number calculation unit 62, an optimal arrangement unit 63, a unit sum calculation unit 64, and an optimal sum total calculation unit 65.

The optimal area calculation unit 61 receives the illumination sensor simulation starting signal from the distribution unit 24, sets an optimal area of an illumination sensor as D1 (for example, D1 is 36 m² and is changeable) in terms of the accuracy of measurement and installation expense. The illumination-sensor optimal area D1 is then provided to the optimal number calculation unit 62.

The optimal number calculation unit 62 receives the illumination-sensor optimal area D1 from the optimal area calculation unit 61, and calculates an optimal number QO(L) of illumination sensors as expressed in Equation 7.

QO(L)=int((ST+D1)/D1), Eq. 7

where ST is the area of a room/corridor

The optimal number calculation unit 62 provides the optimal number QO(L) of illumination sensors to the optimal arrangement unit 63 and the optimal sum total calculation unit 65.

The optimal arrangement unit 63 receives room/corridor information from the structure information unit 23 and the optimal number of illumination sensors from the optimal number calculation unit 62 to calculate the optimal position of the illumination sensors.

An optimal horizontal position of the illumination sensors may be set at the centers of, e.g., 6 m×6 m squares. However, when it is unable to dispose the illumination sensors at the centers of the squares, the illumination sensors may be disposed at the centers of remaining area. For example, assuming that a total area of a room is an 11 m×12 m, the room is first portioned four squares of 6 m×6 m, and a remaining area of 5 m×12 m is further partitioned into a 3 m×12 m rectangular and a 2 m×12 m rectangular. Then, the illumination sensors are arranged at the centers of the four squares of 6 m×6 m, the 3 m×12 m rectangular and the 2 m×12 m rectangular. An optimal vertical position of the illumination sensors may be set at a position that is separated by 1.5 m upward from a bottom. Under such a condition, 2D/3D arrangement coordinates for the illumination sensors are calculated, and the calculated 2D/3D optimal arrangement coordinates are provided to the position display unit 107 as shown in FIG. 1B.

The unit sum calculation unit 64 receives the illumination sensor simulation starting signal from the distribution unit 24 to set a unit sum of an illumination sensor. In this case, the unit sum calculation unit 64 may set the illumination-sensor unit sum as D2 (for example, D2 is 200,000 [symbol] , and is changeable), and the illumination-sensor unit sum calculation unit 64 provides the illumination-sensor unit sum D2 to the optimal sum total calculation unit 65.

The optimal sum total calculation unit 65 receives the optimal number QO(L) of humidity sensors from the optimal number calculation unit 62 and the illumination-sensor unit sum D2 from the unit sum calculation unit 64 to calculate an optimal sum total COT(L) of illumination sensors as expressed in Equation 8.

COT(L)=D2×QO(L) Eq. 8

Subsequently, the optimal sum total calculation unit 65 provides the optimal sum total COT(L) of the illumination sensors to the sum display unit 108 as shown in FIG. 1B.

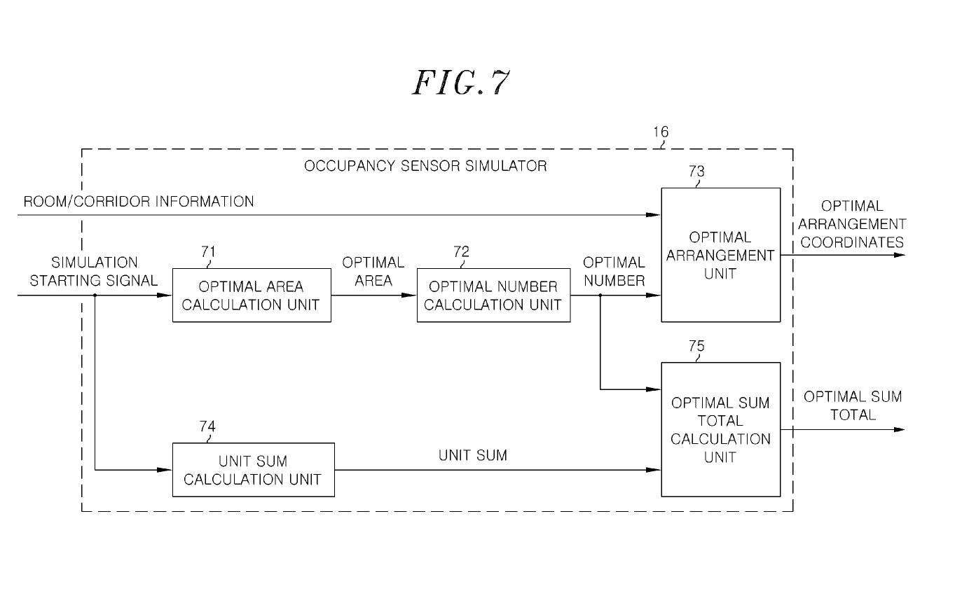

FIG. 7 illuminates the detailed block diagram of the occupancy sensor simulator 16 shown in FIG. 1A in accordance with an embodiment of the present invention. The occupancy sensor simulator 16 includes an optimal area calculation unit 71, an optimal number calculation unit 72, an optimal arrangement unit 73, a unit sum calculation unit 74, and an optimal sum total calculation unit 75.

The occupancy-sensor optimal area calculation unit 71 receives the occupancy sensor simulation starting signal from the distribution unit 24 and sets an optimal area of an occupancy sensor as E1 (for example, E1 is 36 m², and is changeable) in terms of the accuracy of measurement and installation expense. The occupancy-sensor optimal area E1 is then provided to the optimal number calculation unit 72.

The optimal number calculation unit 72 receives the occupancy-sensor optimal area E1 from the optimal area calculation unit 71, and calculates an optimal number QO(M) of occupancy sensors as expressed in Equation 9.

QO(M)=int((ST+E1)/E1), Eq. 9

where ST is the area of a room/corridor

The optimal number calculation unit 72 provides the optimal number QO(M) of occupancy sensors to the optimal arrangement unit 73 and the optimal sum total calculation unit 75.

The optimal arrangement unit 73 receives room/corridor information from the structure information unit 23 and the optimal number QO(M) of occupancy sensors from the optimal number calculation unit 72 to calculate an optimal position of an occupancy sensor.

An optimal horizontal position of the occupancy sensors may be set at the centers of, e.g., a 6 m×6 m squares. However, when it is unable to dispose the occupancy sensors at the centers, the occupancy sensors may be disposed at the centers of remaining areas, as described above. An optimal vertical position of the occupancy sensors may be set at a ceiling. Under such a condition, 2D/3D arrangement coordinates for occupancy sensors are calculated, and the calculated 2D/3D optimal arrangement coordinates are provided to the position display unit 109 as shown in FIG. 1B.

The unit sum calculation unit 74 receives the occupancy sensor simulation starting signal from the distribution unit 24 to set a unit sum of an occupancy sensor. In this case, the unit sum calculation unit 74 may set the occupancy-sensor unit sum as E2 (for example, E2 is 250,000 [symbol] , and is changeable). The occupancy-sensor unit sum E2 is then provided to the optimal sum total calculation unit 75.

The optimal sum total calculation unit 75 receives the optimal number QO(M) of occupancy sensors from the optimal number calculation unit 72 and the occupancy-sensor unit sum E2 from the unit sum calculation unit 74 to calculate an optimal sum total COT(M) of occupancy sensors as expressed in Equation 10.

COT(M)=E2×QO(M) Eq. 10

Subsequently, the optimal sum total calculation unit 75 provides the optimal sum total COT(M) of the occupancy sensors to the sum display unit 110 as shown in FIG. 1B.

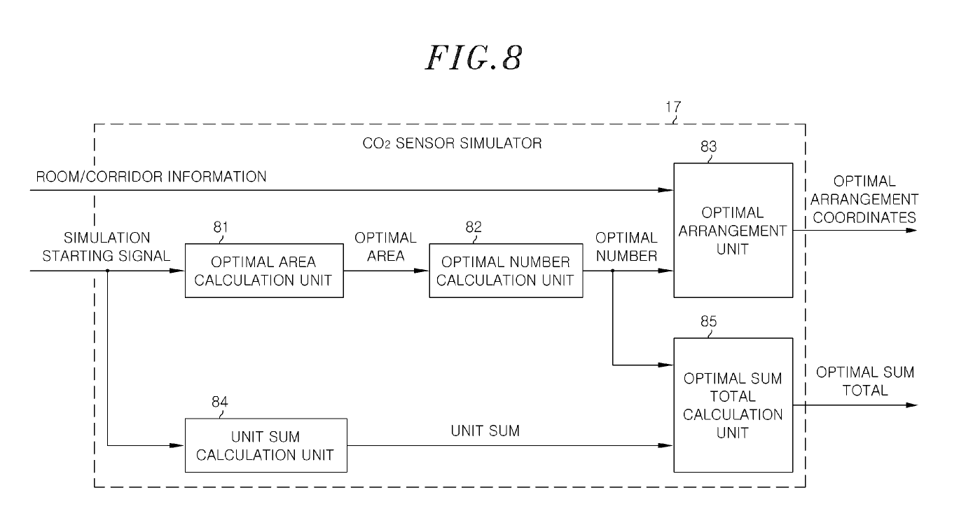

FIG. 8 illustrates the detailed block diagram of the CO₂ sensor simulator 17 shown in FIG. 1A in accordance with an embodiment of the present invention. The CO₂ sensor simulator 17 includes an optimal area calculation unit 81, an optimal number calculation unit 82, an optimal arrangement unit 83, a unit sum calculation unit 84, and an optimal sum total calculation unit 85.

The optimal area calculation unit 81 receives the CO₂ sensor simulation starting signal from the distribution unit 24 and sets an optimal area of a CO₂ sensor as F1 (for example, F1 is 100 m², and is changeable) in terms of the accuracy of measurement and installation expense. The CO₂-sensor optimal area F1 is then provided to the optimal number calculation unit 82.

The optimal number calculation unit 82 receives the CO₂-sensor optimal area F1 from the optimal area calculation unit 81, and calculates an optimal number QO(CO₂) of CO₂ sensors as expressed in Equation (11).

QO(CO₂)=int((ST+F1)/F1), Eq. 11

where ST is the area of a room/corridor

The optimal number calculation unit 82 provides the optimal number QO(CO₂) of CO₂ sensors to the optimal arrangement unit 83 and the optimal sum total calculation unit 85.

The optimal arrangement unit 83 receives room/corridor information from the structure information unit 23 and the optimal number F1 of CO₂ sensors from the optimal number calculation unit 82 to calculate an optimal position of a CO₂ sensor.

An optimal horizontal position of the CO₂ sensor may be a position PO(CO₂) along the long central line of a room/corridor, wherein PO(CO₂)=point(i/(QO(CO₂)+1)) of an entire length, where i is an integer from one to QO(CO₂). An optimal vertical position of the CO₂ sensor may be set at the central position between a ceiling and a bottom. However, when it is unable to dispose the CO₂ sensor at the central position, the CO₂ sensor may be disposed at the ceiling. Under such a condition, 2D/3D arrangement coordinates for CO₂ sensors are calculated, and the calculated 2D/3D optimal arrangement coordinates are provided to the position display unit 111 as shown in FIG. 1B.

The unit sum calculation unit 84 receives the CO₂-sensor simulation starting signal from the distribution unit 24 to set a unit sum of a CO₂ sensor. In this case, the unit sum calculation unit 84 sets the CO₂-sensor unit sum as F2 (for example, F2 is 250,000 [symbol] , and is changeable), and the unit sum calculation unit 84 provides the CO₂-sensor unit sum F2 to the optimal sum total calculation unit 85.

The optimal sum total calculation unit 85 receives the optimal number QO(CO₂) of CO₂ sensors from the optimal number calculation unit 82 and the CO₂-sensor unit sum F2 from the unit sum calculation unit 84 to calculate an optimal sum total COT(CO₂) of CO₂ sensors as expressed in Equation 12.

COT(CO₂)=F2×QO(CO₂) Eq. 12

Subsequently, the optimal sum total calculation unit 85 provides the optimal sum total COT(CO₂) of CO₂ sensors to the sum display unit 112 as shown in FIG. 1B.

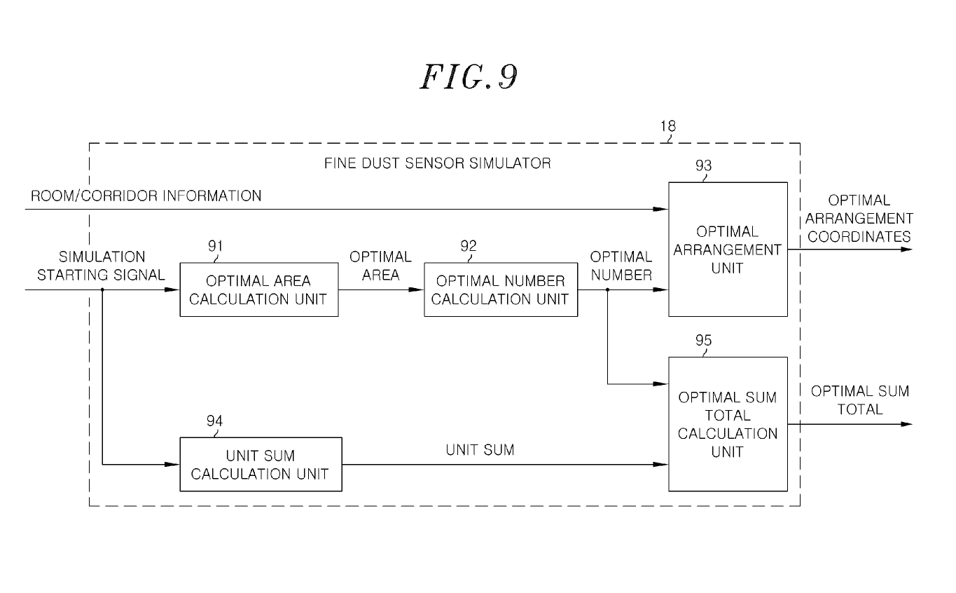

FIG. 9 illustrates the detailed block diagram of the fine dust sensor simulator 18 shown in FIG. 1A in accordance with an embodiment of the present invention. The fine dust sensor simulator 18 includes an optimal area calculation unit 91, an optimal number calculation unit 92, an optimal arrangement unit 93, a unit sum calculation unit 94, and an optimal sum total calculation unit 95.

The fine dust-sensor optimal area calculation unit 91 receives the fine dust-sensor simulation starting signal from the distribution unit 24 and sets an optimal area of a fine dust sensor as G1 (for example, G1 is 100, and is changeable) in terms of the accuracy of measurement and installation expense. The fine dust-sensor optimal area G1 is then provided to the optimal number calculation unit 92.

The optimal number calculation unit 92 receives the fine dust-sensor optimal area G1 from the optimal area calculation unit 91, and calculates an optimal number QO(D) of fine dust sensors as expressed in Equation 13.

QO(D)=int((ST+G1)/G1), Eq. 13

where ST is the area of a room/corridor

The optimal number calculation unit 92 provides the optimal number QO(D) of fine dust sensors to the optimal arrangement unit 93 and the optimal sum total calculation unit 95. The optimal arrangement unit 93 receives room/corridor information from the structure information unit 23 and the optimal number QO(D) of fine dust sensors from the optimal number calculation unit 92 to calculate an optimal position of a fine dust sensor.

An optimal horizontal position of the fine dust sensor may be a position PO(D) along the long central line of a room/corridor, wherein PO(D)=point(i/(QO(D)+1)) of an entire length, where i is an integer from one to QO(D). An optimal vertical position of the fine dust sensor may be set at the central position between a ceiling and a bottom. However, when it is unable to dispose the of the fine dust sensor at the central position, the fine dust sensor may be disposed at the ceiling. Under such a condition, 2D/3D arrangement coordinates of fine dust sensors are calculated, and the calculated 2D/3D optimal arrangement coordinates are provided to the position display unit 113 as shown in FIG. 1B.

The unit sum calculation unit 94 receives the fine dust-sensor simulation starting signal from the distribution unit 24 to set a unit sum of a fine dust sensor. In this case, the unit sum calculation unit 94 sets the fine dust-sensor unit sum as G2 (for example, G2 is 250,000 [symbol] , and is changeable), and the unit sum calculation unit 94 provides the fine dust-sensor unit sum G2 to the optimal sum total calculation unit 95.

The optimal sum total calculation unit 95 receives the optimal number QO(D) of fine dust sensors from the optimal number calculation unit 92 and the fine dust-sensor unit sum G2 from the unit sum calculation unit 94 to calculate an optimal sum total COT(D) of fine dust sensors as expressed in Equation 14.

COT(D)=G2×QO(D) Eq. 14

Subsequently, the optimal sum total calculation unit 95 provides the optimal sum total COT(D) of fine dust sensors to the sum display unit 114 as shown in FIG. 1B.

In the building energy management system, the embodiments of the present invention automatically arranges and displays the temperature sensor, the humidity sensor, the temperature-humidity sensor, the illumination sensor, the occupancy sensor, the CO₂ sensor, and the fine dust sensor that are used for managing and controlling building energy and environment, in a 2D or 3D space. Further, the embodiment of the present invention calculates and display the optimal sum total for each of the sensors, on the basis of floor information of a building and structural information of rooms and corridors by floor which are inputted by a user, in terms of the accuracy of measurement and installation expenses for sensors to be installed in the building. Accordingly, the embodiments of the present invention enable the energy control sensors to be optimally arranged in the building.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for optimally and automatically arranging a plurality of energy control sensors in a building, the apparatus including:
an input module configured to receive building information, floor information of the building, structural information of rooms and corridors for each floor of the building, and information on one or more energy control sensors to be installed in the building;
a sensor simulation module configured to calculate arrangement coordinates and installation expense for each of the energy control sensors to be installed in the building; and
an output module configured to output the arrangement coordinates and the installation expense, which have been calculated by the sensor simulation module for each energy control sensor to be installed.

2. The apparatus of claim 1, wherein the input module includes:
a building information unit configured to store the building information and information on sizes and shapes of the floors, rooms, and corridors of the building;
a floor information unit configured to store information on the floors of the building;
a structure information unit configured to store information on the rooms and corridors in each of the floors of the building, on the basis of the information on the floors; and
a distribution unit configured to provide sensor simulation starting signals for the energy control sensors to be installed to the sensor simulation module, on the basis of the information, stored in the floor information unit and the structure information unit, on the floor and room of each corridor, so that the sensor simulation module calculates the arrangement coordinates and installation expense for each of the selected energy control sensors.

3. The apparatus of claim 1, wherein the sensor simulator module includes:
an optimal area calculation unit configured to calculate an optimal area of each energy control sensor to be installed in the building;
an optimal number calculation unit configured to calculate an optimal number of energy control sensors to be installed in the building on the basis of the calculated optimal area;
an optimal arrangement unit configured to determine an installation position of each energy control sensor to be installed in the building on the basis of the calculated optimal number and the information on the room and corridor of the building;
an optimal unit sum calculation unit configured to calculate an optimal unit sum of each energy control sensor; and
an optimal sum total calculation unit configured to calculate an optimal sum total of energy control sensors to be installed in the building on the basis of the calculated unit sum and the calculated optimal number.

4. The apparatus of claim 3, wherein the optimal area calculation unit calculates an optimal area that each energy control sensor to be installed covers, in consideration of a measurement accuracy and installation expense of each energy control sensor.

5. The apparatus of claim 1, wherein each of the energy control sensors include a temperature sensor, a humidity sensor, a temperature-humidity sensor, an illumination sensor, an occupancy sensor, a CO₂ sensor, or a fine dust sensor.

6. A method of optimally and automatically arranging a plurality of energy control sensors in a building, the method comprising:
providing building information, floor information of the building, structural information of rooms and a corridor for each floor of the building;
providing information on one or more energy control sensors to be installed in the building;
calculating arrangement coordinates and installation expense for each of the energy control sensors to be installed in the building; and
outputting information on the calculated arrangement coordinates and the calculated installation expense for each of the energy control sensors to be installed in the building.

7. The method of claim 6, further comprising:
storing information on floors of the building; and
storing the structural information on sizes and shapes of the rooms and corridors for each floor of the building.

8. The method of claim 6, wherein said providing information on one or more energy control sensors to be installed in the building comprises:
providing information on the energy control sensors to be installed in the rooms and corridors of each floor on the basis of the information on the floors, rooms, and corridors of the building; and
providing a sensor simulation starting signal for the energy control sensors to be selected to calculate the arrangement coordinates and installation expense for each of the identified energy control sensors.

9. The method of claim 6, wherein said calculating arrangement coordinates and installation expense includes:
calculating an optimal area of each energy control sensor to be installed in the building;
calculating an optimal number of energy control sensors to be installed in the building on the basis of the calculated optimal area;
determining an optimal installation position of each energy control sensor in the building on the basis of the calculated number and the information on the rooms and corridors of the building;
calculating an optimal unit sum of energy control sensors to be installed in the building; and
calculating an optimal sum total of energy control sensors to be installed in the building on the basis of the calculated unit sum and the calculated number.

10. The method of claim 9, wherein said calculating an optimal area includes calculating the optimal area that each energy control sensor covers, in consideration of a measurement accuracy and installation expense of each energy control sensor.

11. The method of claim 6, wherein each of the energy control sensors include a temperature sensor, a humidity sensor, a temperature-humidity sensor, an illumination sensor, an occupancy sensor, a CO₂ sensor, or a fine dust sensor.
